(19) United States
(12) Patent Application Publication
(10) Pub. No.: US 2025/0143293 A1
(43) Pub. Date: May 8, 2025

(54) ANTITRANSPIRANT COMPOSITION FOR PLANTS

(71) Applicant: COROMANDEL INTERNATIONAL LIMITED, Telangana (IN)

(72) Inventors: Sadhasivam KATHIRESAN, Telangana (IN); Ponnusamy MANIMARAN, Telangana (IN); Chinaga SURESH KUMAR, Telangana (IN); Palanisamy KESESWARI, Telangana (IN)

(73) Assignee: COROMANDEL INTERNATIONAL LIMITED, Telangana (IN)

(21) Appl. No.: 18/937,423

(22) Filed: Nov. 5, 2024

(30) Foreign Application Priority Data
Nov. 6, 2023 (IN) 202341075811

(51) Int. Cl. A01N 31/02; A01N 25/02; A01N 25/30; A01P 21/00; C05C 3/00; C05G 3/50; C05G 5/23

(52) U.S. Cl. CPC A01N 31/02; A01N 25/02; A01N 25/30; A01P 21/00; C05C 3/00; C05G 3/50; C05G 5/23

(57) ABSTRACT

The present invention relates to the field of increasing tolerance to abiotic stress in plants. More particularly the present invention relates to an anti-transpirant composition for plants for increasing tolerance to environmental changes and abiotic stresses in plants to obtain reduced transpiration, better growth and providing a substantial yield advantage.

### FIELD OF THE INVENTION

The present invention relates to the field of increasing tolerance to abiotic stress in plants. More particularly, the present invention relates to an anti-transpirant composition for plants for increasing tolerance to environmental changes and abiotic stresses in plants to obtain reduced transpiration, better growth and providing a substantial yield advantage.

### BACKGROUND OF THE INVENTION

Plants are living in an innately harsh environment ever since their emergence on planet Earth. Numerous environmental factors including both physical or chemical factors are hostile to them, including low or high temperature, deficient or excessive water, high salinity, heavy metals, and ultraviolet (UV) radiation, among others. These stresses, collectively referred to as abiotic stresses, are posing a severe threat to agriculture and the ecosystem, accounting for great crop yield loss.

Also, the increasing population and global climate change have played a role in creating various abiotic stresses that are major threats for global food security. Therefore, one of the major challenges of this era is to maintain a sustainable yield under these stresses and meet the global food demand with nutritional food.

A healthy plant provides good yield and quality of desired plant products. A healthy plant is defined by its ability to withstand biotic (pathogens, insects, etc.) stresses as well as abiotic (cold, heat, drought, etc.) stresses. A plant succumbing to the infection by pests and/or environmental stresses is considered a weak plant which does not provide good yield and quality of products.

Abiotic stress can be defined as the adverse impacts created by the abiotic factors on the plant tissues. Abiotic stress is caused by non-living factors that are in contrast to biotic stress, which is caused by living organisms. Abiotic stresses negatively impact the growth and development of plants and result in significant reductions in crop yield and quality. Abiotic stresses include excessive or insufficient light intensity, cold temperature resulting in freezing or chilling, warm or high temperature, drought, ozone, salinity, toxic metals, nutrient poor soils, and the like. Abiotic stress factors are often sporadic and highly localized in nature. Plants can experience abiotic stress resulting from the shortage of an essential resource or from the presence of high concentrations of a toxic or antagonistic substance. Further, exposure to prolonged exposure to abiotic stresses results in a greater susceptibility to biotic stresses such as pathogens and pests.

An adverse consequence of the stress factors is on the plant growth and development. As plants are stationary in nature, they have to confront the stresses and develop potent adaptive tactics to avoid or tolerate the adverse effects of environmental factors so as to survive and to thrive. Plants counter to particular stress conditions using responses that are specific for that stress. For example, during drought conditions, it is desirable that a plant loses less water which is done by closing its stomata. However, plants are often subjected to a combination of stresses. For example, drought conditions often are combined with excessive heat conditions. In contrast to response to drought, a plant's response to heat is to open stomata so that the leaves are cooled by transpiration. This conflict in response reduces a plant's ability to naturally adjust to such stresses.

Hence, there remains a need to provide an anti-transpirant composition for enhancing the tolerance of the plants to abiotic stress such as increased rate of transpiration. The present invention provides a composition for enhancing tolerance to abiotic stress such as increased rate of transpiration and maintaining the relative water content in the foliar cells.

### SUMMARY OF THE INVENTION

The present invention provides an anti-transpirant composition for increasing tolerance to abiotic stress comprising of fatty alcohol ethoxylate present in a range from 20% to 40% (wt./wt.); diluent present in a range from 20% to 40% (wt./wt.); fertilizer present in a range from 0.5% to 5% (wt./wt.); inorganic salts present in a range from 1.5% to 8% (wt./wt.); dispersant present in a range from 0.20% to 2% (wt./wt.); neutralizer present in a range from 0.50% to 5% (wt./wt.); carrier present in a range from 10% to 15% (wt./wt.); surfactant present in a range from 2.5% to 10% (wt./wt.); anti-foaming agent present in a range from 2.5% to 10% (wt./wt.); and thickener present in a range from 0.50% to 5% (wt./wt.).

In an embodiment of the present invention, the fatty alcohol ethoxylate is a mixture of ethoxylated fatty glyceride, Cetostearyl alcohol ethoxylate, and lauryl alcohol ethoxylate.

In another embodiment of the present invention, the diluent is water.

In another embodiment of the present invention, the fertilizer is selected from the group comprising ammonium sulphate, potassium carbonate, aluminium potassium silicate, humic acid potassium salt, calcium carbonate and calcium acetate monohydrate.

In yet another embodiment of the present invention, the inorganic salt is potassium bi carbonate, tri calcium phosphate and mixture thereof.

In yet another embodiment of the present invention, the dispersant is selected from the group comprising sodium dodecyl sulphate, calcium sulphate, dihydrate and mixture thereof.

In yet another embodiment of the present invention, the neutralizer is phosphoric acid.

In yet another embodiment of the present invention, the carrier is selected from the group comprising sesame oil, sunflower oil, corn oil and soybean oil.

In yet another embodiment of the present invention, the surfactant is selected from the group comprising of Tween 20, Tween 85, Span 20, Span 80 and Span 85.

In yet another embodiment of the present invention, the anti-foaming agent is selected from the group comprising of silicon surfactant, glycerine, mineral oils, and sulfonated castor oil.

In yet another embodiment of the present invention, the thickener is selected from the group comprising guar gum, carboxy methyl cellulose and xanthan gum.

### BRIEF DESCRIPTION OF THE FIGURES

FIGS. 1A-1C show transplantation shock study in tomato plants. FIG. 1A shows plot sprayed with composition of the present invention at 3 ml/L, FIG. 1B shows plot sprayed with composition of the present invention at 5 ml/L and FIG. 1C shows control untreated water.

FIG. 2 shows increased height in seedlings treated with compositions of present invention when compared to control. T1 is composition of the present invention at 3 ml/L dose, T2 is composition of the present invention at 5 ml/L dose and T3 is control untreated water.

FIG. 3 shows increased plant height, root length and number of leaves in seedlings treated with compositions of present invention when compared to control water.

FIG. 4A shows cut flowers before treatment and FIG. 4B shows cut flowers three days after treatment with compositions of the present invention.

FIGS. 5A and 5B show cross-section of black gram leaf of untreated control (FIG. 5A) and leaf treated with composition of the present invention (FIG. 5B).

FIG. 6 shows the Physiological response of plants under stress in terms of biochemical parameters, enzymes and hormones.

FIG. 7 is an illustrative scheme for preparation of anti-transpirant compositions of the present invention.

### DETAILED DESCRIPTION OF THE INVENTION

The following detailed description is presented to enable any person skilled in the art to make and use the invention. For purposes of explanation, specific nomenclature is set forth to provide a thorough understanding of the present application. However, it will be apparent to one skilled in the art that these specific details are not required to practice the invention. Descriptions of specific applications are provided only as representative examples. The present application is not intended to be limited to the embodiments shown but is to be accorded the widest possible scope consistent with the principles and features disclosed herein.

Unless defined otherwise, all technical and scientific terms used herein have the same meanings as commonly understood by one of skill in the art to which the disclosed method and compositions belong. It must be noted that as used herein and in the appended claims, the singular forms “a”, “an”, and “the” include plural reference unless the context clearly dictates otherwise. Thus, for example, reference to “a plant nutrient” includes “one or more” plant nutrients or a “plurality” of such nutrients.

Similarly, the words “comprise”, “comprises”, and “comprising” are to be interpreted inclusively rather than exclusively. Likewise, the terms “include”, “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” is also a disclosure of embodiments “consisting essentially of” and “consisting of” the disclosed components. Where used herein, the term “example”, particularly when followed by a listing of terms, is merely exemplary and illustrative, and should not be deemed to be exclusive or comprehensive. Any embodiment disclosed herein can be combined with any other embodiment disclosed herein unless explicitly indicated otherwise.

The present invention provides a composition for increasing tolerance to abiotic stress particularly to reduce rate of transpiration in a plant or part thereof wherein a plant or part thereof when treated with compositions of the present invention exhibits increased tolerance to abiotic stress of the plant or part thereof as compared to a control plant or part thereof exposed to the same abiotic stress but not treated with the compositions of the present invention.

For the purpose of the present invention “increased tolerance to abiotic stress” refers to the ability of a plant or part thereof to withstand the abiotic stress on exposure to abiotic stress. Increased tolerance to abiotic stress can be indicated by a variety of parameters including, but not limited to, the size and number of plants or parts thereof, and the like (e.g., number and size of fruits), the level or amount of cell division, the amount of floral abortion, the amount of sunburn damage, crop yield, and the like.

In an embodiment of the present invention, the anti-transpirant composition comprises of fatty alcohol ethoxylate present in a range from 20% to 40% (wt./wt.); diluent present in a range from 20% to 40% (wt./wt.); fertilizer present in a range from 0.5% to 5% (wt./wt.); inorganic salts present in a range from 1.5% to 8% (wt./wt.); dispersant present in a range from 0.20% to 2% (wt./wt.); neutralizer present in a range from 0.50% to 5% (wt./wt.); carrier present in a range from 10% to 15% (wt./wt.); surfactant present in a range from 2.5% to 10% (wt./wt.); anti-foaming agent present in a range from 2.5% to 10% (wt./wt.); and thickener present in a range from 0.50% to 5% (wt./wt.).

In another embodiment of the present invention, the active ingredient fatty alcohol ethoxylate is a mixture of ethoxylated fatty glyceride, Cetostearyl alcohol ethoxylate, lauryl alcohol ethoxylate, present in a range from 20% to 40% (wt./wt.). Fatty alcohol ethoxylate reduces the water loss by reflecting greater amount of incident light falling on the leaf. It helps plants to recover from thermic and/or cold stress and improves resistance to drought and frost. It helps plants to maintain the relative water content of the plant cells.

In yet another embodiment of the present invention, water is used as a diluent.

In yet another embodiment of the present invention, the fertilizer is selected from the group comprising of ammonium sulphate, potassium carbonate, aluminium potassium silicate, humic acid potassium salt, calcium carbonate, calcium acetate, monohydrate and mixture thereof.

In yet another embodiment of the present invention, inorganic salts are potassium bicarbonate, tricalcium phosphate and mixture thereof. Potassium bicarbonate is used for maintaining the quality and increasing the yield of the crops. Tricalcium Phosphate promotes more photosynthesis and higher brix. The phosphates not only help produce the sugar but also bring it to the roots where it's excreted to soil microbes. Then, the microbes make more nutrients that become available to the plant, so the plant can make more sugar.

In yet another embodiment of the present invention, the composition of the present invention comprises of dispersant sodium dodecyl sulphate and calcium sulphate, dihydrate. The dispersant function is to lower the surface tension between the active ingredients of the present invention i.e., water, carrier oil, and fatty alcohol ethoxylate to create a homogeneous mixture of water, carrier oil, and fatty alcohol ethoxylate.

In yet another embodiment of the present invention, the composition of the present invention comprises phosphoric acid as neutralizer.

In yet another embodiment of the present invention, the composition of the present invention comprises of carrier selected from the group comprising of sesame oil, sunflower oil, corn oil and soybean oil.

In yet another embodiment of the present invention, the composition of the present invention comprises of surfactant selected from Tween 20, Tween 85, Span 20, Span 80 and Span 85.

In yet another embodiment of the present invention, the composition of the present invention comprises of anti-foaming agent selected from silicon surfactant, glycerine, mineral oils, and sulfonated castor oil.

In yet another embodiment of the present invention, the composition of the present invention comprises of thickener selected from the group comprising of guar gum, carboxy methyl cellulose and xanthan gum.

In yet another embodiment of the present invention, the anti-transpirant composition of the present invention comprises of active fatty alcohol ethoxylate, water, ammonium sulphate, tri calcium phosphate, potassium bi carbonate, sodium dodecyl sulphate, phosphoric acid, sesame oil, Tween 20, silicon surfactant, and guar gum.

In yet another embodiment of the present invention, the anti-transpirant composition comprises of fatty alcohol ethoxylate present in a range from 20% to 40% (wt./wt.), water present in a range from 20% to 40% (wt./wt.), ammonium sulphate present in a range from 0.50% to 5% (wt./wt.), potassium bi carbonate present in a range from 1% to 3% (wt./wt.), tri calcium phosphate present in a range from 0.50% to 5% (wt./wt.), sodium dodecyl sulphate present in a range from 0.20% to 2% (wt./wt.), phosphoric acid present in a range from 0.50% to 5% (wt./wt.), sesame oil present in a range from 10% to 15% (wt./wt.), Tween 20 present in a range from 2.5% to 10% (wt./wt.), silicon surfactant present in a range from 2.5% to 10% (wt./wt.), and guar gum present in a range from 0.50% to 5% (wt./wt.).

In yet another embodiment of the present invention, the present invention also provides a process for the preparation of the anti-transpirant composition for increasing the tolerance of plants to stress conditions. For the purpose of the present invention the process of preparing the composition comprises of following steps: a required amount of inorganic salts like tricalcium phosphate, Potassium bi carbonate and fertilizers are mixed with water at 500 rpm to 2000 rpm for 20 minutes to 4 hours followed by addition of sesame oil and is mixed for 30 minutes at 500 rpm to 2000 rpm until a white homogenous solution is obtained. To the white homogenous solution phosphoric acid for neutralization and water is added and mixed for 30 minutes at 500 rpm to 2000 rpm. Followed by addition of Tween-20, Silicone surfactant, Guar gum and mixed at 500 rpm to 2000 rpm for 60 minutes. Subsequently fatty alcohol ethoxylate is added and mixed at 500 rpm to 2000 rpm for 120 minutes. The product so obtained in homogenized by passing through a high-pressure homogenizer for cycle at 250 bar and the product is observed for stability for 24 hours. If the product remains homogeneous and no phase separation or sedimentation is observed the product is packed for shipping and use.

The compositions of the present invention are useful for any type of plant or part thereof exposed to or which may become exposed to an abiotic stress like excessive sunlight or drought. The compositions of the present invention are useful for increasing tolerance in plants including, but not limited to, gymnosperms, angiosperms (monocots and dicots), ferns, bryophytes, and combinations thereof.

The composition of the present invention helps plants to maintain the relative water content in the foliar cells which in turn will keep the stomata partially opened, leading to protection to the plants from abiotic stress such as cold or hot stress and improves resistance to drought and frost.

In some aspects of the invention, the step of contacting the plant or part thereof includes any method by which the compositions of the invention are brought into contact with the plant or part thereof. The term “contact” comprises any method in which a plant is exposed to, provided with, or in which a compound is applied to a plant or part thereof. Some non-limiting examples of contacting a plant or part thereof include spraying, dusting, sprinkling, scattering, misting, atomizing, broadcasting, soaking, soil injection, soil incorporation, drenching (e.g., soil treatment), pouring, coating, leaf or stem infiltration, side dressing or seed treatment, and the like, and combinations thereof. These and other procedures for contacting a plant or part thereof with compound(s), composition(s) or formulation(s) are well-known to a person skilled in the art.

The surface of the plant and part thereof for the present invention includes the plant and parts thereof that are above and below the ground. In some embodiments of this invention, the composition is contacted with/applied to the surface of the plant or plant part, and composition is then absorbed into the plant.

The following examples are included to demonstrate various embodiments of the invention. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention.

### Example 1: Anti-Transpirant Composition of the Present Invention

The components of the anti-transpirant composition are taken in requisite amount in accordance with Table 1 and prepared by process as shown in Example 2. The specific compositions for the purpose of the present invention are illustrated in Table 2 to Table 4.

TABLE 1
Composition of anti-transpirant composition

| | | | Range % |
|---|---|---|---|
| S. No. | Components | Function | (wt./wt.) |
| 1. | Fatty alcohol ethoxylate | Active Ingredient | 20% to 40% |
| 2. | Water | Diluent | 20% to 40% |
| 3. | Ammonium sulphate | Fertilizer | 0.5% to 5% |
| 4. | Potassium bi carbonate | Inorganic salt | 1% to 3% |
| 5. | Tri calcium phosphate | Inorganic salt | 0.5% to 5% |
| 6. | Sodium dodecyl sulphate | Dispersant | 0.2% to 2% |
| 7. | Phosphoric acid | Neutralizer | 0.5% to 5% |
| 8. | Sesame oil | Carrier | 10% to 15% |
| 9. | Tween-20 | Surfactant | 2.5% to 10% |
| 10. | Silicon surfactant | Antifoaming agent | 2.5% to 10% |
| 11. | Guar gum | Thickener | 0.5% to 5% |

TABLE 2
Composition of anti-transpirant composition of the present invention.

| S. No. | Components | Function | wt./wt. (%) |
|---|---|---|---|
| 1 | Fatty alcohol ethoxylate | Active Ingredient | 40.00 |
| 2 | Water | Filler or diluent | 36.50 |
| 3 | Ammonium | Fertilizer | 0.50 |
| | sulphate | | |
| 4 | Potassium bi carbonate | Inorganic salt | 3.00 |
| 5 | Tri calcium phosphate | Inorganic salt | 0.50 |
| 6 | Sodium dodecyl sulphate | Dispersant | 0.20 |
| 7 | Phosphoric acid | Neutralizer | 0.50 |
| 8 | Sesame | Carrier | 12.30 |
| | oil | | |
| 9 | Tween-20 | Surfactant | 3.50 |
| 10 | Silicon surfactant | Antifoaming agent | 2.50 |
| 11 | Guar gum | Thickener | 0.50 |

TABLE 3
Composition of anti-transpirant composition of the present invention.

| S. No | Components | Function | Range (%) |
|---|---|---|---|
| 1 | Fatty alcohol ethoxylate | Active Ingredient | 30.00 |
| 2 | Water | Diluent | 40.00 |
| 3 | Ammonium sulphate | Fertilizer | 1.00 |
| 4 | Potassium bi carbonate | Inorganic salt | 2.00 |
| 5 | Tri calcium phosphate | Inorganic salt | 1.00 |
| 6 | Calcium sulphate, dihydrate | Dispersant | 1.00 |
| 7 | Phosphoric | neutralizer | 1.00 |
| | acid | | |
| 8 | Corn oil | Carrier | 10.00 |
| 9 | Span 20 | Surfactant | 5.00 |
| 10 | Glycerine | Antifoaming agent | 5.00 |
| 11 | Carboxy methyl cellulose | Thickener | 4.00 |

TABLE 4
Composition of anti-transpirant composition of the present invention.

| S. No | Components | Function | Range (%) |
|---|---|---|---|
| 1 | Fatty alcohol ethoxylate | Active Ingredient | 20.00 |
| 2 | Water | Diluent | 35.00 |
| 3 | Ammonium sulphate | Fertilizer | 5.00 |
| 4 | Potassium bi carbonate | Inorganic salt | 3.00 |
| 5 | Tri calcium phosphate | Inorganic salt | 5.00 |
| 6 | Sodium dodecyl sulphate | Dispersant | 2.00 |
| 7 | Phosphoric acid | Neutralizer | 5.00 |
| 8 | Soybean oil | Carrier | 12.50 |
| 9 | Span 80 | Surfactant | 2.50 |
| 10 | Sulfonated castor oil | Antifoaming agent | 5.00 |
| 11 | Xanthan gum | Thickener | 5.00 |

### Example 2: Process for the Preparation of Anti-Transpirant Composition for Increasing the Tolerance of Plants to Stress Conditions

The process of preparing the composition for increasing tolerance of plants comprises of following steps: 4.2 Kg of inorganic salt like tricalcium phosphate, potassium bicarbonate and fertilizers are mixed with 10 Kg of water at 2000 rpm for 60 minutes followed by addition of 12.30 Kg of sesame oil and is mixed for 30 minutes at 2000 rpm until a white homogenous solution is obtained. To the white homogenous solution 0.5 Kg of phosphoric acid for neutralization and 26.5 Kg of water is added and mixed for 30 minutes at 2000 rpm. Followed by addition of 3.5 Kg of Tween-20, 2.50 Kg of Silicone surfactant, 0.5 Kg of Guar gum and mixed at 2000 rpm for 60 minutes. Subsequently 40 Kg of fatty alcohol ethoxylate is added and mixed at 2000 rpm for 120 minutes. The product so obtained is homogenized by passing through a high-pressure homogenizer for cycle at 250 bar and the product is observed for stability for 24 hours. If the product remains homogeneous and no phase separation or sedimentation is observed the product is packed for shipping and use. A schematic of the process is illustrated in FIG. 7.

### Example 3: Transplantation Shock Study in Tomato

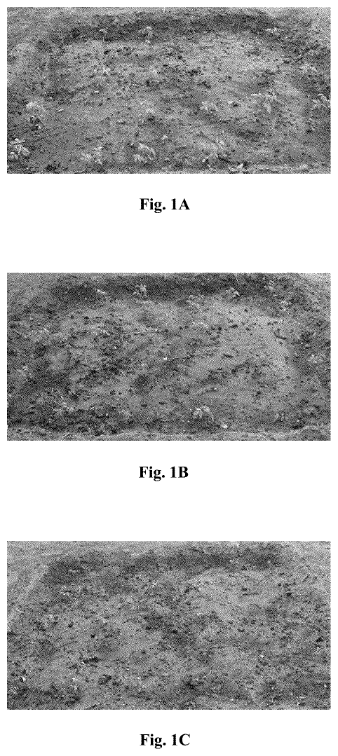

A semi field study was carried out for determining the effect of the anti-transpirant compositions of the present invention in tomato. The location for study was R&D centre, Thiyagavalli. A plot size of 4.5 sqm with 30 plants per plot was sprayed thrice for study of transplantation shock. T1, T2 are compositions of the present invention and T3 is control (water). Tomato seeds were transplanted and were irrigated immediately after transplanting, followed by a second watering 5 days later to facilitate the establishment of seedlings. Seedlings were uprooted to take observation for plant height, root length, number of leaves, number of plants survived and wilting. Three plants were taken randomly per treatments for observation. The data collected were recorded and represented in Table 5. As shown in FIG. 1A, 21 plants got established out of 30 plants when plants are sprayed with T1@ 3 ml/L, FIG. 1B, 20 plants got established out of 30 plants when plants are sprayed with T2@ 5 ml/L, and FIG. 1C, 17 plants got established out of 30 plants when plants are sprayed with control.

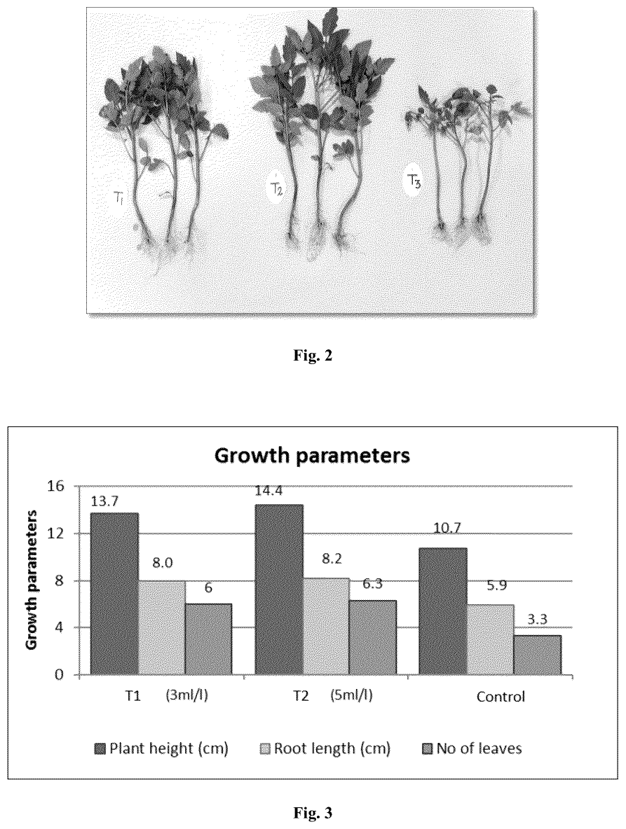

FIG. 2, and FIG. 3 illustrate that seedlings treated with compositions of the present invention recorded higher plant height, stem grith, root length and number of leaves and also there was increase in number of plants survived after transplanting shock compared to control plants. The data for FIG. 2 and FIG. 3 is shown in Table 5.

TABLE 5
Transplanting shock study in Tomato

| | Avg plant | Avg root | | No. of plants | |
|---|---|---|---|---|---|
| | height | length | No. of | survived/ | |
| Treatment | (cm) | (cm) | leaves | treatment | Wilting |
| T1 @ 3 ml/L | 13.7 | 8.0 | 6.0 | 21 | 0 |
| T2 @ 5 ml/L | 14.4 | 8.2 | 6.3 | 20 | 0 |
| T3 Control | 10.7 | 5.9 | 3.3 | 17 | 1 |

0 - no transplanting shock,
1- transplanting shock

### Example 4: Life of Cut Flower

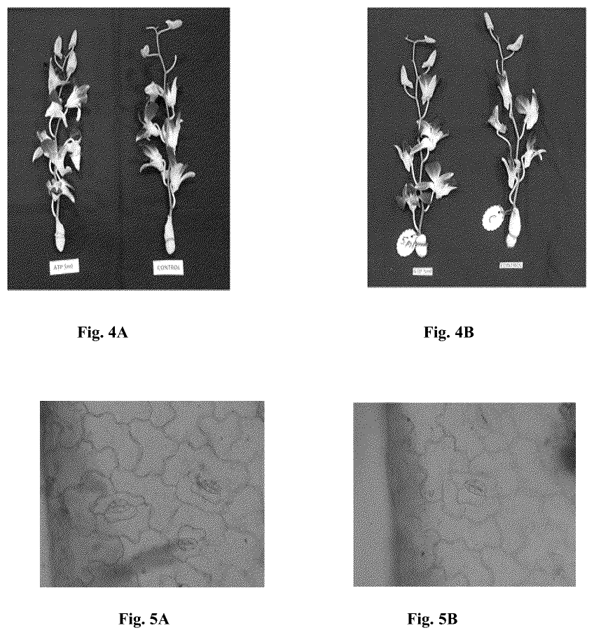

As shown in FIGS. 4A and 4B, cut flower treated with compositions of the present invention appears fresh even after 3 days of storage whereas in untreated control it is observed that the flowers withers from stem within 3 days.

### Example 5: Effect of Composition of the Present Invention on Leaf Area and Stomata

The number of stomata is normally gene controlled and characteristic of species/varieties of plant. In the present example the effect of the composition of the present invention on leaf area and stomata is studied on plant Phaseolus. In Phaseolus plants the stomatal density is higher during the flowering stage but not so in the younger leaves. The number of stomata per leaf is fixed, but the area of the leaf increases normally during the vegetative phase. It was observed that the increase in leaf area is more in plants treated with compositions of the present invention, but the number of stomata is same, hence lesser number of stomata per leaf area. This observation indicates there must be an aquaporin protein facilitated enhancement of the cell-to-cell pathway of water movement within the leaf that enables the plants to keep the stomatal aperture open and at the same time keeps a reduced leaf temperature, so that loss of water is reduced, which results in the maintenance of the turgidity of cells facilitating enhanced photosynthate production. Thus, the composition of the present invention lowers the transpiration rate due to lesser stomatal frequency. The effect of anti-transpirant composition of the present invention is shown in FIGS. 5A and 5B, which show cross-section of black gram leaf of untreated control (FIG. 5A) and leaf treated with composition of the present invention (FIG. 5B).

### Example 6: Biochemical Analysis of Plants Treated with Compositions of the Present Invention

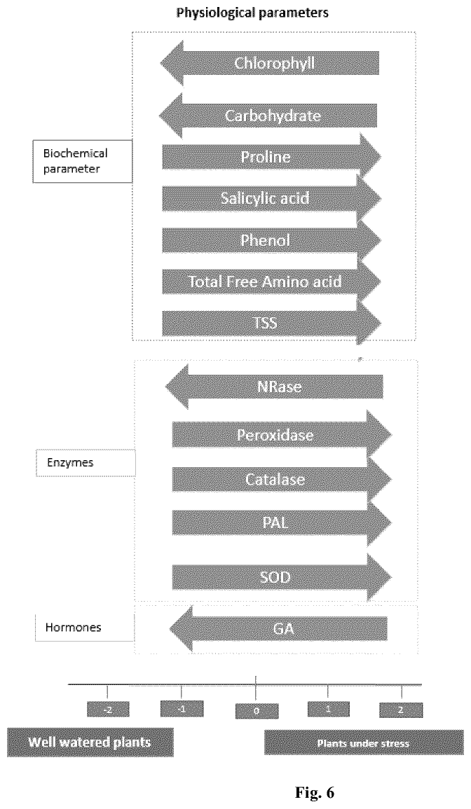

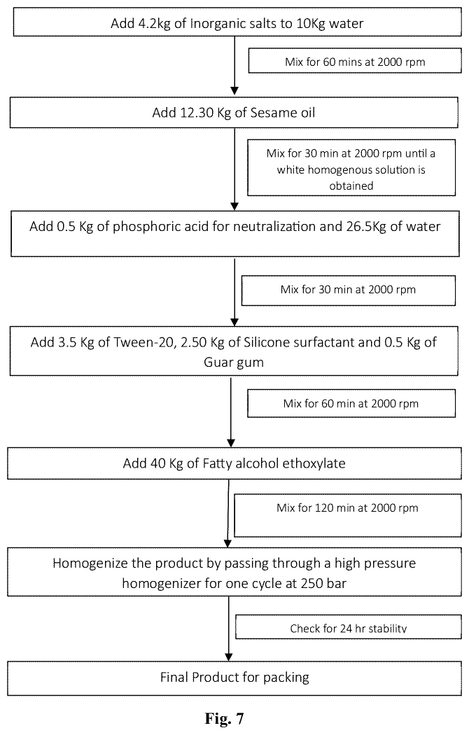

Water loss through transpiration is one of the main causes of loss of water from the soil through the plants. Reduction in the loss of water through transpiration will maintain turgidity in plant cells. This can be done either through reflecting excess sunlight falling on the leaves leading to maintaining the turgidity (relative water content of the cells). Plants were sprayed with compositions of the present invention, commercial product and control 53 days after sowing. The physiological response of plants under stress is studied under three categories on biochemical parameters, enzyme parameters and hormone. The effect of abiotic stress on biochemical parameters, enzyme parameters and hormones are illustrated in FIG. 6.

In biochemical analysis as shown in Table 6, Total Chlorophyll content (mg/g fresh leaves), Carbohydrate content (mg/g fresh weight) and Gibberellic Acid content (micro gram/100 mg fresh weight) was found higher in leaves treated with composition of the present invention than commercial product and in untreated control leaves which indicates that the spraying of composition of the present invention helps the plant to retrieve from stress thereby reducing transpirations losses in plants. In nitrate reductase (micro mole nitrite/100 mg fresh weight) alone the value was found lower in leaves treated with composition of the present invention than commercial product since ammoniacal form of Nitrogen is provided, the quantum of nitrates is not enhanced which is directly proportional to nitrate reductase. The plants grown in normal environmental condition will have low Proline content (mg/g fresh weight), Salicylic acid (micro gram/g fresh weight), Total phenol (mg GAE/g fresh weight), Total free amino acid (mg/g fresh weight), Total soluble solids (Brix), Peroxidase (unit/mg protein), Catalase (unit/mg protein), Phenyl alanine ammonium lyase (unit/mg protein), Super oxide dismutase (unit/mg protein). The biochemical values of above parameters was found lower in leaves treated with composition of the present invention than commercial product and in untreated control.

TABLE 6
Biochemical analysis of plants

| | Composition | | |
|---|---|---|---|
| | of the | | |
| BIOCHEMICAL | present | Commercial | |
| PARAMETERS | invention | product | Control |
| Total Chlorophyll | 3.1 | 2.1 | 3.0 |
| (mg/g fresh leaves) | | | |
| Total free amino acid | 69.9 | 83.1 | 86.1 |
| (mg/g fresh weight) | | | |
| Proline content | 101.2 | 134.0 | 148.0 |
| (mg/g fresh weight) | | | |
| Carbohydrate | 434.0 | 397.7 | 253.4 |
| (mg/g fresh weight) | | | |
| Super oxide dismutase | 3.8 | 3.9 | 4.3 |
| (SOD) (unit/mg protein) | | | |
| Phenyl alanine | 4.0 | 7.9 | 5.7 |
| ammonium lyase (PAL) | | | |
| (unit/mg protein) | | | |
| Catalase (unit/mg protein) | 120.2 | 123.4 | 129.6 |
| Peroxidase | 11.2 | 16.4 | 19.3 |
| (unit/mg protein) | | | |
| Nitrate reductase (NRase) | 4.7 | 8.7 | 9.9 |
| (micro mole nitrite/ | | | |
| 100 mg fresh weight) | | | |
| Gibberellic acid (GA) | 7.2 | 4.6 | 6.5 |
| (microgram/100 mg | | | |
| fresh weight) | | | |
| Total soluble solids (TSS) | 5.0 | 5.3 | 8.3 |
| (Brix) | | | |
| Salicylic acid | 156.3 | 172.7 | 200.0 |
| (micro gram/g fresh weight) | | | |
| Total phenol | 23.7 | 50 | 105.3 |
| (mg GAE/g fresh weight) | | | |

### Example 7: Comparative Data of Yield

The anti-transpirant composition of the present invention is also tested on tomato plant and its effect on the plant is illustrated in Table 7.

TABLE 7
Effect of anti-transpirant composition of the present invention on yield

| | 15 days irrigation interval | | |
|---|---|---|---|
| | Avg. No. of | Avg. Pod | Avg. grain |
| Parameters | pods/plant | weight/plant | weight/plant |
| Composition of the | 8.9 | 3.7 | 2.5 |
| present invention | | | |
| @ 3 ml/L | | | |
| Commercial | 7.4 | 2.9 | 1.9 |
| product @ 3 ml/L | | | |
| Untreated control | 6.8 | 2.4 | 1.6 |

Table 7 shows that average no. of pods per plant are observed to be 8.9 in seeds treated with compositions of the present invention when compared to 7.4 of commercial product. The composition of the present invention also provides increase in yield (Avg. grain wt. 2.5 g/plant) in plot sprayed with composition of the present invention when compared to plot sprayed with commercial product (Avg. grain wt. 1.9 g/plant) at 15 days irrigation interval.

From the foregoing it will be observed that numerous modifications and variations can be effectuated without departing from the scope of the novel concepts of the present invention. It is to be understood that no limitations with respect to the specific embodiments illustrated is intended or should be inferred. It should be understood that all such modifications and improvements have been deleted herein for the sake of conciseness and readability but are properly within the scope of the following claims.

What is claimed is:

1. An anti-transpirant composition for increasing tolerance to abiotic stress comprising of:
fatty alcohol ethoxylate present in a range from 20% to 40% (wt./wt.);
diluent present in a range from 20% to 40% (wt./wt.);
fertilizer present in a range from 0.5% to 5% (wt./wt.);
inorganic salts present in a range from 1.5% to 8% (wt./wt.);
dispersant present in a range from 0.20% to 2% (wt./wt.);
neutralizer present in a range from 0.50% to 5% (wt./wt.);
carrier present in a range from 10% to 15% (wt./wt.);
surfactant present in a range from 2.5% to 10% (wt./wt.);
anti-foaming agent present in a range from 2.5% to 10% (wt./wt.); and
thickener present in a range from 0.50% to 5% (wt./wt.).

2. The composition as claimed in claim 1, wherein fatty alcohol ethoxylate is a mixture of ethoxylated fatty glyceride, Cetostearyl alcohol ethoxylate, and lauryl alcohol ethoxylate.

3. The composition as claimed in claim 1, wherein the diluent is water.

4. The composition as claimed in claim 1, wherein the fertilizer is selected from the group comprising ammonium sulphate, potassium carbonate, aluminum potassium silicate, humic acid potassium salt, calcium carbonate, calcium acetate monohydrate and mixture thereof.

5. The composition as claimed in claim 1, wherein the inorganic salt is potassium bicarbonate, tricalcium phosphate and mixture thereof.

6. The composition as claimed in claim 1, wherein the dispersant is selected from the group comprising sodium dodecyl sulphate and calcium sulphate, dihydrate.

7. The composition as claimed in claim 1, wherein the neutralizer is phosphoric acid.

8. The composition as claimed in claim 1, wherein the carrier is selected from the group comprising sesame oil, sunflower oil, corn oil and soybean oil.

9. The composition as claimed in claim 1, wherein the surfactant is selected from the group comprising of Tween 20, Tween 85, Span 20, Span 80 and Span 85.

10. The composition as claimed in claim 1, wherein the anti-foaming agent is selected from the group comprising of silicon surfactant, glycerine, mineral oils, and sulfonated castor oil.

11. The composition as claimed in claim 1, wherein the thickener is selected from the group comprising guar gum, carboxy methyl cellulose and xanthan gum.
